(19) United States
(12) Patent Application Publication
(10) Pub. No.: US 2010/0276461 A1
(43) Pub. Date: Nov. 4, 2010

(54) Dispensing Cap for Container and Method of Forming Same

(75) Inventor: James P. Stevens, Florence, SC (US)

Correspondence Address: FLASTER/GREENBERG P.C.;Four Penn Center, 1600 John F. Kennedy Boulevard, 2nd Floor, PHILADELPHIA, PA, 19103, US

(73) Assignee: Sonoco Development, Inc., Hartsville, SC (US)

(21) Appl. No.: 12/768,440

(22) Filed: Apr. 27, 2010

Related U.S. Application Data
(60) Provisional application No. 61/173,712, filed on Apr. 29, 2009.

(51) Int. Cl. B67D 7/00; B29C 45/14

(52) U.S. Cl. 222/561; 29/592; 264/242

(57) ABSTRACT

A dispensing cap is provided for a container and includes a body portion having a formed sliding track thereon. An opening is provided in the body for providing access through the body. A retention slot is formed adjacent the sliding track. A slider is moveably positioned within the sliding track for selectively opening and closing the body opening. A frangible tab is initially formed as part of the slider and engaged within the retention slot to fix the position of the slider within the sliding track. Removal of the frangible tab permits the slider to move relative to the body opening. The cap is formed by an injection molding process, in conjunction with an in-mold assembly of the slider.

The present application claims the benefit of the filing date from U.S. Provisional application No. 61/173,712, filed Apr. 29, 2009.

### FIELD OF THE INVENTION

The present invention relates to a cap or closure to be applied to a container, with the closure forming means for controlling the discharge of a quantity of material retained within the container.

### BACKGROUND OF THE INVENTION

A number of forms of caps and closures are known for covering the upper end of a container and for selectively controlling the discharge of material from the container. One form of cap includes a sliding member retained by guide rails. The sliding member covers an opening in the cap and is moveable between an open position and a closed position.

U.S. Pat. No. 4,592,480 to Hart et al. shows a tamper-evident cap having a two-part construction with a connecting tearaway tab or strip. In one embodiment, the tearaway tab is formed on one side of the cap and is connected to the slider and to a base portion. The tab can be removed so that the slider may be moved relative to the cap to control discharge from the container.

U.S. Pat. No. 3,355,069 to Miles shows a slideable closure that is retained within rails on a cap. The slider includes an end portion that forms a cutter for shearing off projections in the upper surface to open the cap. In one embodiment shown, a knife edge is fixed on the slider as part of an overmolding process.

U.S. Pat. No. 4,925,067 to Zemlo et al. shows a dispensing cap having a slider secured by rails and moveable in opposite directions to access openings in the surface of the cap. The slider and cap may be made of different materials to control friction between the moving parts.

U.S. Pat. No. 6,102,259 to Tsamourgelis et al. shows a cap for a container having an integrally formed slider that sits between rails on the upper surface of the cap. A pair of elastic arms connect the slider to the cap and serve as a spring that moves the slider to a normally closed position. The slider has a T-shaped end that creates a limit stop for the slider as it moves toward the normally closed position.

In addition, it is known to overmold parts within a plastic structure made of dissimilar materials, such that the final assembly permits the parts to functionally fuse, but not materially fuse. An integrally-molded bearing block assembly formed by an in-mold assembly process is shown in U.S. Pat. No. 5,049,341 to Rubinstein.

### SUMMARY OF THE INVENTION

A dispensing cap for a container is provided, with the cap adapted to close the open end of the container so as to retain a quantity of material therein and to selectively discharge the material. The cap includes a body portion having a formed sliding track thereon. The sliding track may be defined by a pair of parallel rails, projecting from or otherwise formed on the body. An opening is provided in the body for providing access to the quantity of material within the container. A retention slot is formed adjacent the sliding track. A slider is moveably positioned within the sliding track. A frangible tab is formed on the slider and is engaged within the retention slot to fix the position of the slider prior to removal of the tab. A stop member may be positioned at one end of the sliding track. The stop member serves to engage the slider to prevent movement of the slider within the track, past the stop member. The retention slot may be formed in the stop member. The retention slot may alternatively be formed within one of the rails, with the frangible tab extending from the slider in a direction transverse to the rail.

A method of forming a cap for a container is also contemplated, comprising the steps of forming a container body having a sliding track thereon. The sliding track may be defined by a pair of rails positioned on opposite sides of the body portion. The upper surface of the body is formed with an opening for providing access to a quantity of material within the container on which the cap is to be positioned. A retention slot is formed adjacent the sliding track. A slider is moveably positioned within the sliding track for selectively opening and closing the body opening. A frangible tab may be formed on the slider at a position for engagement within the retention slot to fix the position of the slider. The body of the cap may be formed by an injection molding process. Further, the slider may be molded by an in-mold assembly within the formed body portion. The frangible tab is integrally formed with the slider and may be formed during the in-mold assembly of the slider within the retention slot.

Other features of the present invention will become apparent from the detailed description to follow, taken in conjunction with the accompanying drawings.

### BRIEF DESCRIPTION OF THE DRAWINGS

For the purpose of illustrating the invention, the drawings show forms that are presently preferred. It should be understood that the invention is not limited to the precise arrangements and instrumentalities shown in the drawings.

FIG. 1 shows a dispensing cap embodiment as contemplated by the present invention.

FIG. 2 shows the dispensing cap of FIG. 1 wherein a frangible tab is removed from its connection to a slider.

FIG. 3 shows the dispensing cap of FIGS. 1 and 2 wherein the slider is provided in a dispensing position.

FIG. 4 shows the dispensing cap of FIGS. 1-3 wherein the slider is shown in an alternate dispensing position.

FIG. 5 is a cross-sectional view of the dispensing cap taken along line 5-5 in FIG. 1.

FIGS. 6A and 6B graphically show the molding of the dispensing cap portion and its corresponding slider of the type contemplated by FIGS. 1-5.

FIG. 7 shows a second embodiment of a dispensing cap having a slider positioned within a sliding track thereon.

FIG. 8 shows the dispensing cap of FIG. 7 wherein a frangible tab is separated from a slider portion.

FIG. 9 shows a further embodiment of a dispensing cap of the type contemplated by the present invention.

FIG. 10 shows a top view of the dispensing cap of FIG. 9 wherein a frangible tab is separated from a slider portion.

FIG. 11 shows a bottom view of the dispensing cap of FIGS. 9 and 10 wherein the slider is positioned in a first open position.

FIG. 12 shows a bottom view of FIGS. 9-11 wherein the slider is positioned in a second open position.

FIG. 13 shows the dispensing cap of FIGS. 9-12 wherein the slider is positioned in a closed position.

### DETAILED DESCRIPTION

In the figures, where like numerals identify like elements, there is shown a number of embodiments of a dispensing cap for a container or the like (not shown). It is contemplated that the container may be separately formed from the dispensing cap, with structures provided on the cap for adhering the cap to the open end of the container and to retain the quantity of material to be stored within the container. Alternatively, the cap may be integrally formed with the container body or otherwise secured to the container.

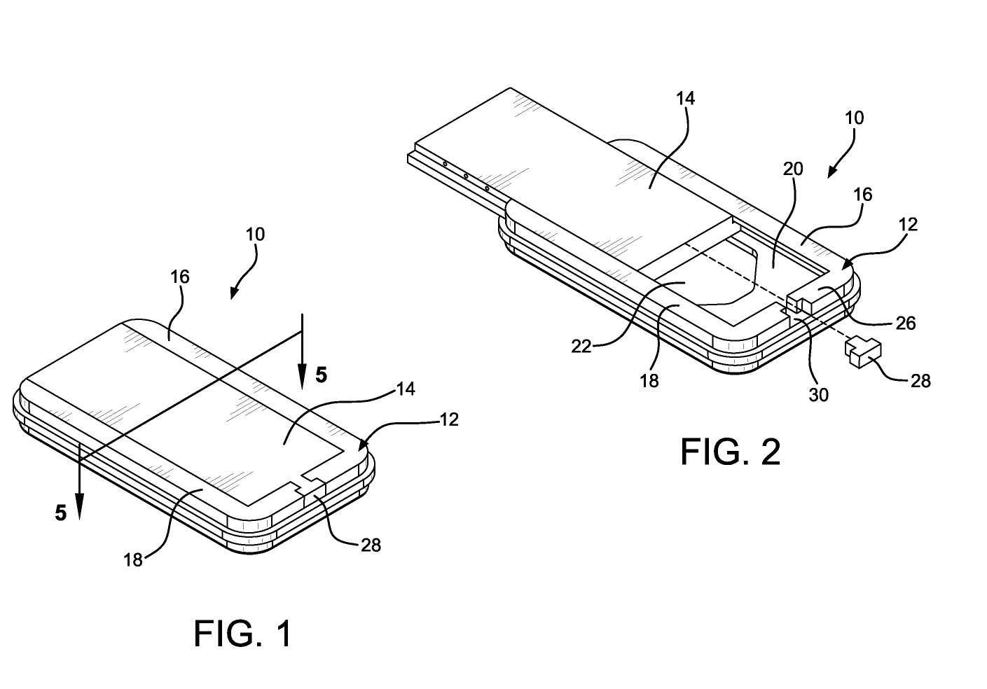

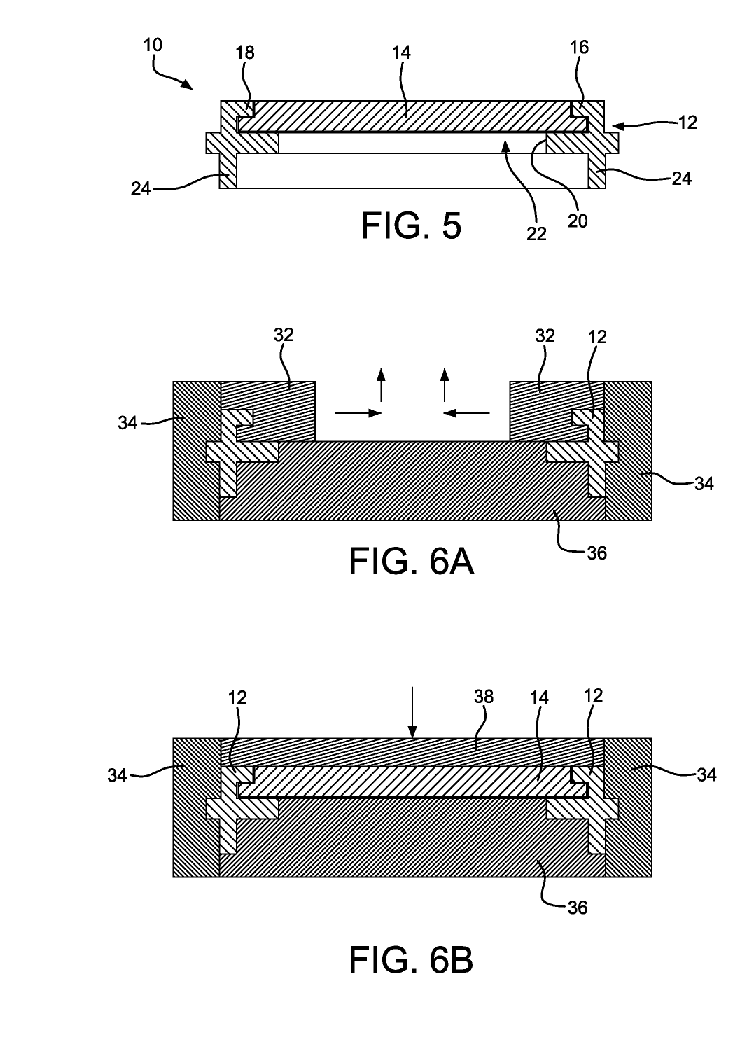

In FIGS. 1-5, there is shown an embodiment of a dispensing cap, which is generally identified by the numeral 10. The cap 10 comprises a rectangular body portion 12 and slider 14. Side rails 16 and 18 are formed parallel to one another and project from opposite sides of an upper surface 20 of the body 12. As illustrated in cross section in FIG. 5, the rails 16, 18 have an inwardly projecting portion, which overlaps with a portion of the slider 14 to retain the slider within an elongated sliding track on the upper surface 20 of the body 12. An opening 22 is provided in the body 12 for access to the interior of the container (not shown) to which the cap 10 is to be attached. As shown in FIG. 5, a downwardly projecting flange 24 is formed on the bottom of the body 12. The flange 24 is used to secure the cap 10 to the upper rim of the container to enclose the opening formed thereby.

The slider 14 is normally positioned within the sliding track formed by the rails 16, 18. A frangible tab 28 is positioned at one end of the slider 14, as shown in FIG. 1. Separation of the frangible tab 28 from the slider 14 permits the slider to move away from a stop member 26 formed at the end of the body 12 (see FIG. 2). The frangible tab 28 is positioned within a retention slot 30 provided in the stop member 26.

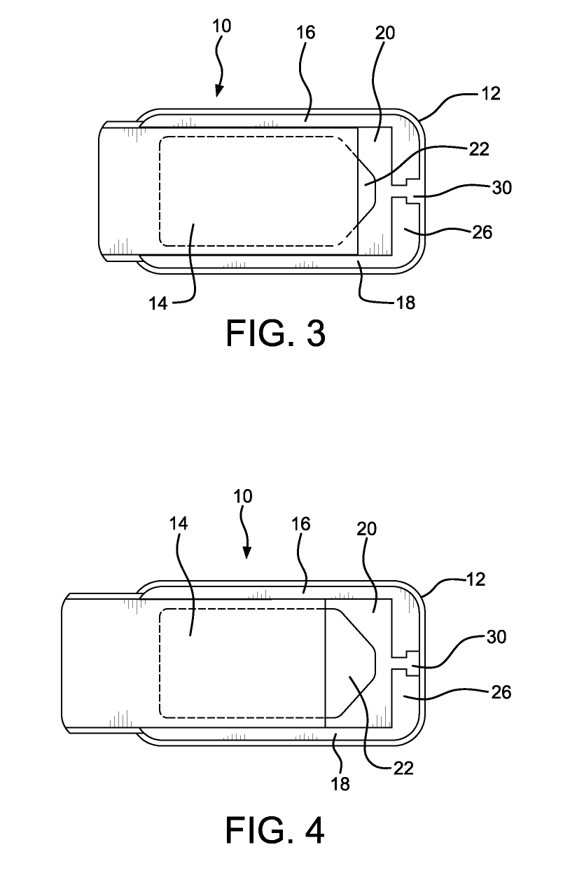

As shown in FIGS. 3 and 4, the slider 14 is moveable along the sliding track and covers at least a portion of the body opening 22. The slider 14 may be moved into a number of positions, as represented by FIGS. 3 and 4, to adjust the size of the opening 22. Changing the size of the opening 22 serves to control the flow of material from the container through the dispensing cap 10. Further movement of the slider 14 to increase the exposed opening permits greater flow of material through the opening 22.

As graphically shown in FIGS. 6A and 6B, the body portion 12 and slider 14 may be formed in an injection molding process. A number of mold parts 32, 34 and 36, as illustrated in FIG. 6A, combine to form a cavity for molding of the body portion 12. In this figure, a simplistic formation of the mold is illustrated. After molding the body portion 12, mold parts 32 are moved inwardly to clear the formed rails and then moved upwardly to move out of the way.

As illustrated in FIG. 6B, a further mold part 38 is positioned over the formed body portion 12, creating a cavity for molding the slider 14. The cavity for the slider 14 is in-part defined by the formed portions of the body 12. Thus, the slider is formed in an in-mold assembly process.

An in-mold assembly of the cap 10 is accomplished by a strategic resin selection for the body portion 12 and the slider 14. For example, the material of the body can be chosen to have a melt temperature higher than the material of the slider. Thus, the slider material does not fuse with or chemically bond to the material of the body, or its associated rails, during the molding of the slider. It is contemplated that the body portion of the cap may be formed from polypropylene, which may have a talc filling therein. This type material will assist in marrying the cap with the container and allow for the use of ultrasonic bonding of elements, if desired. This type material is also compatible with various type spices and other products. The talc is used to deter excessive shrinkage and can contribute to proper adhesion. The slider is preferably made from a crystal polystyrene. This type material is compatible with the polypropylene of the cap in the in-mold assembly process. Polystyrene and polypropylene tend to not create a molecular bond when molded against one another. Although the melting temperatures of these materials are relatively close, the lack of a molecular bond during the molding process is contemplated to produce the desired freedom between the body and slider for in-mold assembly. In addition, the use of a polystyrene for the slider is contemplated to provide the tab portion of the slider with the appropriate level of stiffness so as to be easily broken off when opening is desired.

In the in-mold assembly of the cap 10, the frangible tab 28 of the slider 14 is formed within the retention slot 30 of the stop member 26. The tab 28 is integrally formed with the slider 14. A frangible extension connects the tab 28 forming a T-shaped projection. The slider 14 is formed under the rails 16, 18 during the in-mold assembly process and the tab 28 is formed on the opposite side of the stop member 26 from the slider 14. Thus, deformation of the slider 14 is not required in order to assemble the cap 10. A destructive force is required to remove the tab 28 in order to free the slider 14 from a locked position stop member 26. The tab 28 is preferably formed in this manner to identify tampering.

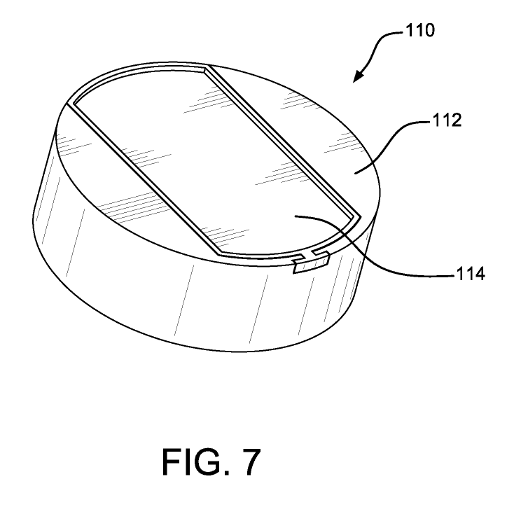

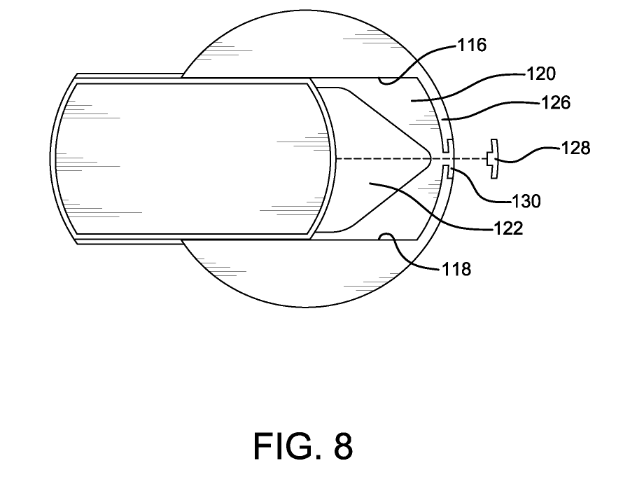

In FIG. 7, a dispensing cap 110 is illustrated having a generally cylindrical body 112 with a slider 114 positioned in a sliding track formed within the body upper surface 120. As shown in FIG. 8, the slider 114 is moved away from a stop member 126, positioned at the end of the side rails 116, 118. The side rails 116, 118 form a sliding track on the upper surface 120 of the cap 110. A retention slot 130 is provided in the stop member 126 for receipt of a frangible tab 128, which is connected to the slider 114. Removal of the tab 128 permits the slider 114 to move within the sliding track to expose the body opening 122. The dispensing cap 112 and its constituent parts may be formed by an in-mold assembly as described above with respect to the embodiments of FIGS. 1-5.

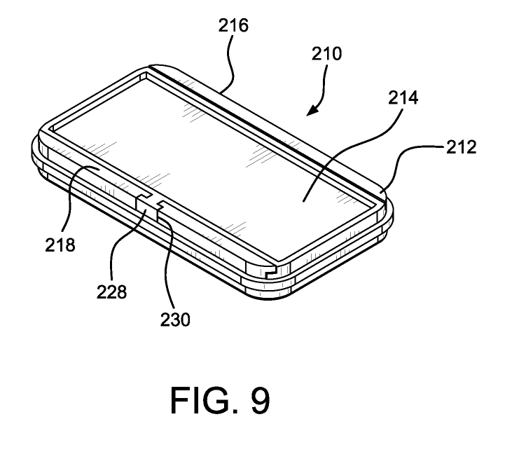

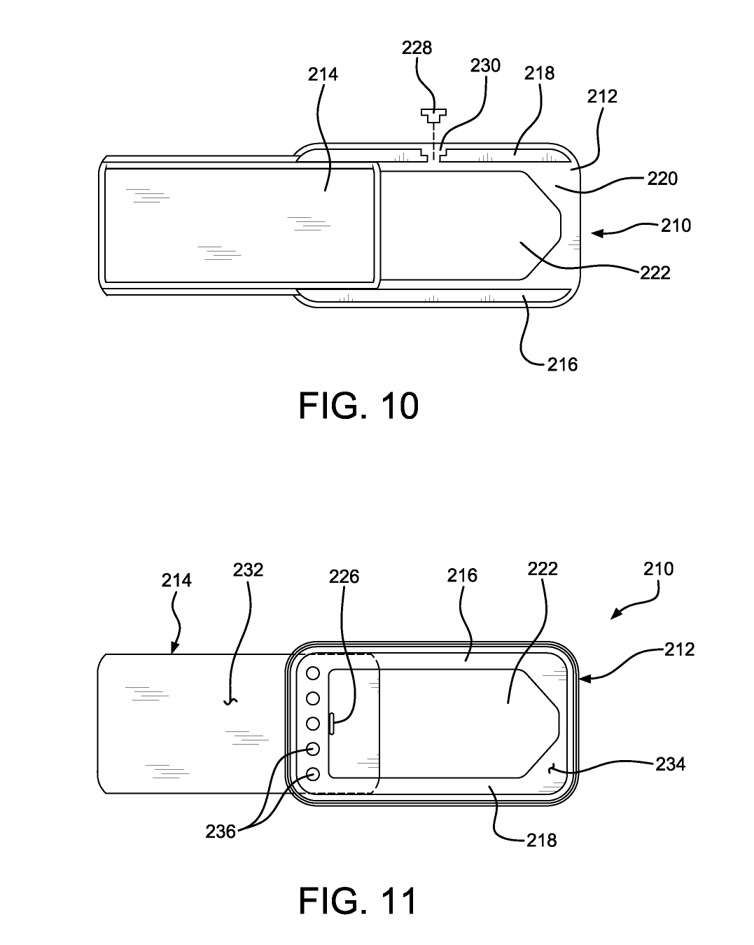

In the embodiment shown in FIGS. 9-13, a dispensing cap 210 is illustrated having a body 212 and a slider 214 positioned between two parallel rails 216, 218. In FIG. 9, the slider 214 is locked in a closed position by tab 218, which is positioned within a retention slot 230 formed in one rail 218. As shown in FIG. 10, removal of the tab 228 from the slider 214 permits the slider 214 to move within the sliding track formed by the rails 216, 218. Movement of the slider 214 within the sliding track exposes the upper surface 220 and its corresponding opening 222.

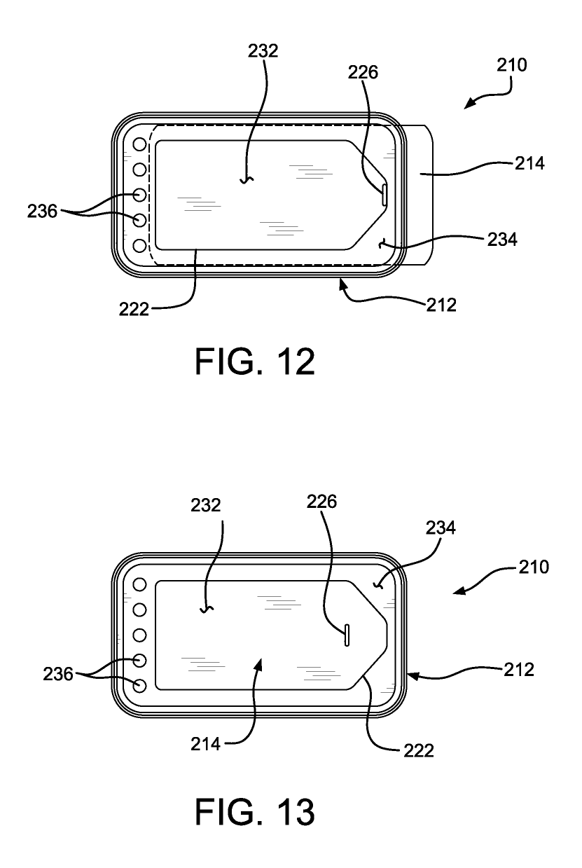

In FIGS. 11-13, the cap 210 is shown from underneath, illustrating the bottom surface 232 of the slider 214 and the bottom surface 234 of the body 212. On the bottom surface 232 of the slider 214 is provided a stop member 226. The stop member 226 is a downward projection which is normally positioned within the opening 222 of the body 212. In FIG. 11, the stop 226 engages with one end of the opening 222. The engagement of the stop 226 defines the maximum open area for the opening 222. In FIG. 12, the stop 226 is positioned in engagement with the opposite end of the opening 222. In this position, the slider 214 exposes a plurality of secondary openings 236, which are provided at the opposite end of the body 212 from the position of engagement of the stop 226. The secondary openings 236 serve as a sifting-type mechanism, as an example, for powdered or granular material retained within a container (not shown). In FIG. 13, the slider 214 is centered over the openings 222 and 236, placing the cap 210 in a closed position. The stop 226 is centered within the opening 222 in the cap body 212.

The cap 210 of FIGS. 9-13 is contemplated to be made by an in-mold assembly process as described above. As such, the stop member 226 as well as the frangible tab 228 may be integrally formed with the slider 214 as part of the molding process. Further, because the slider 214 is molded within a cavity that is in-part defined by the body 212 of the cap 210, deformation of the slider 214 is not required in order for final assembly to be accomplished. Thus, the tab 228 is preferably formed within the retention slot 230 within the rail 218 and the stop 226 is projected into the opening 222 formed in the body 212 upon molding. Additional structures may be added to the slider and the body by the in-mold assembly process whereby separate assembly may require deformation of the parts if a separate assembly process is required after molding.

The present invention has been described and illustrated with respect to a number of exemplary embodiments thereof. It should be understood by those skilled in the art from the foregoing that various other changes, omissions and additions may be made therein, without departing from the spirit and scope of the present invention, with the scope of the present invention being described by the foregoing claims.

What is claimed is:

1. A dispensing cap for a container, the container adapted to retain a quantity of material therein, the cap comprising:
a body portion having
an upper surface,
an opening within the upper surface for providing access through the upper surface,
a sliding track formed on the upper surface, and
a retention slot formed adjacent the sliding track, and
a slider moveably positioned within the sliding track for selectively opening and closing the body opening, the slider having
a frangible tab formed for engagement within the retention slot of the body portion to fix the position of the slider in the slider track prior to removal of the frangible tab.

2. The dispensing cap of claim 1, wherein the body portion further comprises a stop member positioned transverse to the sliding track, the stop member engaging the slider at one end of the sliding track to prevent movement of the slider past the stop member.

3. The dispensing cap of claim 2, wherein the retention slot is formed in the stop member.

4. The dispensing cap of claim 1, wherein the sliding track is defined by a pair of parallel guide rails formed on opposite sides of the upper surface of the body portion, the slider being retained by the rails on the body portion.

5. The dispensing cap of claim 4, wherein the retention slot is formed within one of the rails and the frangible tab is connected to the slider in a direction transverse to the one rail.

6. The dispensing cap of claim 4, wherein the guide rails project from the upper surface of the body.

7. The dispensing cap of claim 1, wherein the body includes a rectangular shape with an elongated sliding track.

8. The dispensing cap of claim 1, further comprising a stop member projecting from the slider into the body opening, the stop member engaging the cap body upon movement of the slider within the sliding track.

9. The dispensing cap of claim 8, further comprising a set of openings positioned in the upper surface adjacent the first mentioned opening, the movement of the slider in one direction within the sliding track exposing the first mentioned opening and the movement of the slider in the opposite direction exposing the set of openings while closing the first mentioned opening.

10. A method of forming a cap for a container comprising the steps of:
forming a cap body having
a pair of parallel guide rails formed on opposite sides of an upper surface of the body and defining a sliding track there between,
an opening in the upper surface for providing access through the cap body, and
a retention slot formed adjacent the sliding track,
forming a slider and positioning the slider between the rails on the body portion for sliding movement within the sliding track and for selectively opening and closing the body opening, and
forming a frangible tab on the slider and engaging the frangible tab within the retention slot of the body portion to fix the position of the slider in the sliding track prior to removal of the frangible tab from the slider.

11. The method of claim 10, wherein the body portion is formed by an injection molding process.

12. The method of claim 11, wherein the slider is molded by an in-mold assembly within the formed body portion.

13. The method of claim 12, wherein the frangible tab is integrally formed with the slider.

14. The method of claim 13, wherein the frangible tab is formed during the in-mold assembly of the slider and formed within the retention slot.

15. The method of claim 10, wherein the forming and positioning steps for the slider are performed at the same time.

16. The method of claim 15, wherein the forming step for the frangible tab is performed simultaneously with the forming step for the slider.

17. The method of claim 16, wherein the retention slot is provided in a stop member formed at one end of the sliding track.

18. The method of claim 16, wherein the retention slot is formed within one of the guide rails and the frangible tab is connected to the slider in a direction transverse to the rail.

19. The method of claim 18, further comprising the step of forming a slider stop on the slider, the slider stop projecting into the opening on the upper surface and engaging the cap body opening upon movement of the slider within the sliding track.
